(19) United States
(12) Patent Application Publication
(10) Pub. No.: US 2021/0045849 A1
(43) Pub. Date: Feb. 18, 2021

(54) DENTAL IMPLANT PLUG

(71) Applicant: Alexandra MARKOPOULOU, Voula Attikis (GB)

(72) Inventor: Alexandra MARKOPOULOU, Voula Attikis (GB)

(21) Appl. No.: 16/760,516

(22) PCT Filed: Oct. 24, 2018
(86) PCT No.: PCT/GR2018/000052

§ 371 Date: Apr. 30, 2020

(30) Foreign Application Priority Data
Oct. 30, 2017 (GB) 20170100487

(51) Int. Cl. A61C 8/00

(52) U.S. Cl. CPC A61C 8/0068; A61C 8/0095

(57) ABSTRACT

Plug-(1,9,10) is a solid shape, fabricated by 3D printers from dental resin, designed in Cylindrical-(1), Conical-(9) and Double Cylindrical-(10) shapes with straight leveled top heads-(2) and with 3 inclined leveled top heads of 30° (3), 45° (4) and 60° (5) for (1,10) with in the center of the top head a shallow Sinkhole-(8) as guidance point and at 0.25 mm a Handling Pin-(6,7) for transport, with a narrow Neck-(7) at the bottom as breaking point after positioning. Plug (1,9,10) is used to close the holes, that are left open after screwing abutments, and prosthetic reconstructions on implants. These screw holes have to be closed. If material obstructs the screw head, it is impossible to unscrew when needed, as screwdrivers will not fit. Plugs are Fabricated precisely in the diameters of the internal walls of the holes, thus creating a friction and a vacuum when placed, and insuring a precise fit without other aids.

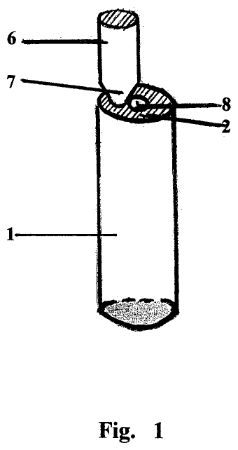

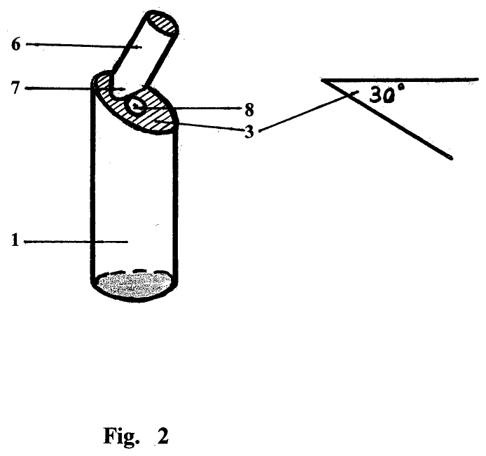

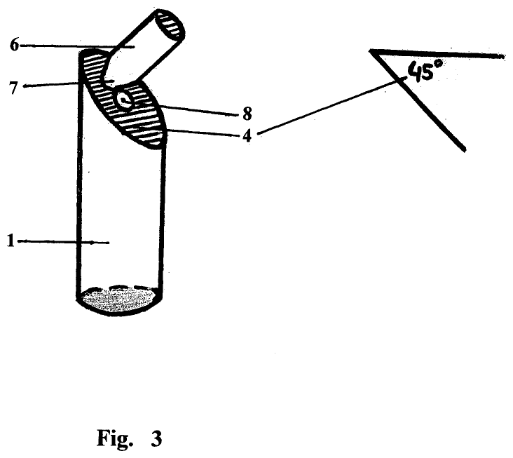

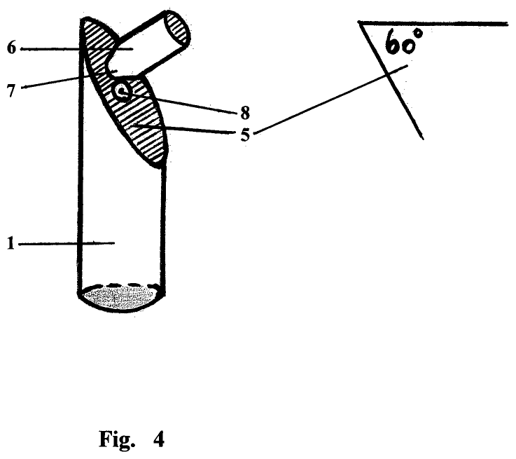

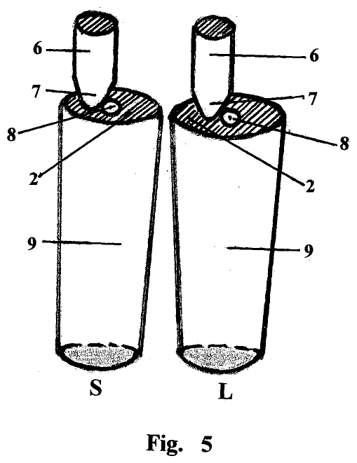

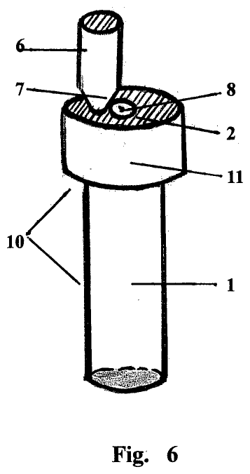

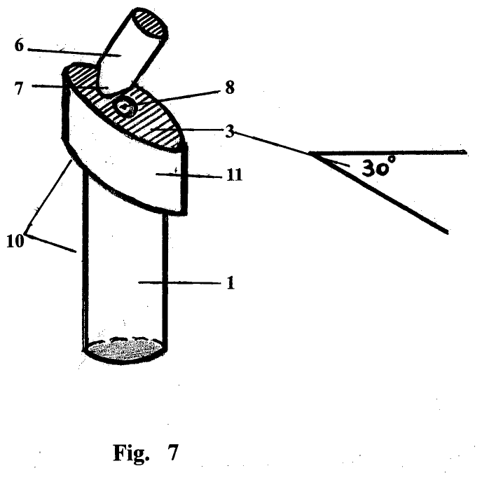

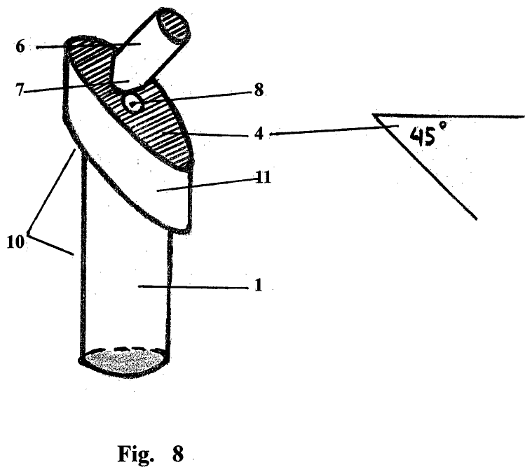

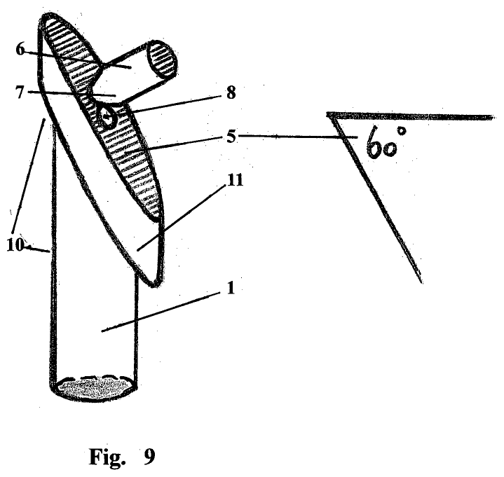

A plug for closing the hole, that is left open after screwing the abutment or the screw retained supra-construction on the implant.

The present invention concerns a prefabricated solid plug of dental resin, that has a shallow sinkhole in the center of the top head of the plug and directly next to it, at a distance of 0.25 mm a handling pin, perpendicular placed, for easy transport and handling of the plug.

The plugs are used:
1) to close the screw holes, that are left open after screwing Abutments on the implants.
2) to close the screw holes, that are left open after placement of Screw Retained single Crowns and multiple unit bridges as well as full arch screw retained bridges like “all on 4” and “all on 6”. In these prosthetic constructions the dental technicians incorporate special Sleeves from titanium or Zirconium to create a pathway for the screwdriver and a connector to finally screw the prosthetic on the implants.

All the Abutments and Sleeves leave open holes and are Cylindrical shaped.
3) to close the screw holes, that are left open after screwing screw-retained single crowns. Here the dental technicians use computer aided software (Cad/Cam) and special porcelain Blocks with pre shaped screw holes in them. These crowns are then designed and milled from these blocks to fit precisely on special Titanium Bases, that form then connectors between the crown and the implant. These holes are Conical shaped.

The general goal of screw retained constructions is to have at all times accessibility to the implants. If the dentist needs to control the implant, the construction on top can be easily unscrewed and screwed again later on, without any damage. Screw holes have to be closed. The screw heads in the base of the hole have to remain protected. If impression material, cement or any other filling material sticks into the screw head, the screw driver does not adapt into the screw head and it becomes impossible to unscrew. So before the impression taking as well as before the final cementation of the crown or bridge, that return from the technician lab, the screw holes in the Abutments have to be closed. After placement of all other screw retained constructions the screw holes in the crowns and in the Sleeves have to be closed.

Screw holes are closed in different ways:

In general, dentists use small cotton pellets or teflon pieces, that are positioned in the base of the screw hole to protect the screw head and keep the pathway for the screw driver free. The use of just cotton or teflon is not sufficient. To close the holes hermetically, solid materials like dental composites, dental resins or acrylics are placed on top of these cotton or teflon parts, initially in a moldable state, where they still can be shaped. Then follows the hardening either by chemical reaction or by photo polymerization. These multiple actions are time consuming, take several minutes per implant in a stage where time is precious to the dentist. The use of cotton and teflon for permanent stay in the oral cavity, even when this is in a closed area as in a screw hole, demonstrates a careless, sloppy act. It is inefficient due to the different handling actions and of inferior quality, compared with the general overall perfectionized dental implant procedures. All Different Multiple actions, without a Standard Protocol. Every dentist has his own way. Cotton or Teflon or even Silicones, that dentists use are not materials Classified or Certified to stay Permanently in the oral cavity. Dentists use cottons to absorb saliva to keep the working area dry or for temporary filling of a tooth, in case of root canal treatments, where the tooth has to be reopened after a few days. But that is Temporary. The general indication to use Cotton or Teflon for Permanent Stay in the mouth is questionable.

The present invention concern Dental Implant Plugs, that are used to close open screw holes, that exist after screwing the different Abutments and prosthetic constructions on the implants. The Plugs are characterized, according to the claims by Cylindrical shapes, Double Cylindrical shapes and Conical shapes. The Cylindrical Plugs and the Double Cylindrical Plugs are characterized, conform the claims by Straight levels or Angled levels top head surfaces. The conical plugs are characterized, according to the claims by only straight leveled top head surfaces. In the center of the top heads of all plugs, conform claims, exist a shallow Sinkhole of 0.5 mm diameter and a depth of 0.5 mm, for easy identification by the dentists and extra orientation for the dentists as the sinkhole is standard positioned in the center of the top head of the Plug. So when unscrewing is demanded, for example for maintenance reasons or for checking the condition of the implants underneath the prosthetic construction, the Sinkhole guides the dentist to drill out the plug in the center and follow the right screw Pathway. The top heads of all Plugs are, conform claims, provided standardly with a Handling Pin, positioned at a 0.25 mm distance to the sinkhole and always perpendicular on any surface, either straight or angled, for easy transportation. In the angled editions the handling pin is situated at the highest point of the top head surface. The characteristics of this pin, conform claims are the narrow neck at the base of the handling pin. This narrow neck serve the easy chipp-off the Pin from the plug at the same spot, when positioning of plug has finished. Plug, Sinkhole and Handling Pin are one single solid body of dental resin. The different plugs are first designed by special designing software, compatible with the 3D Printers and then fabricated by accurate rapid prototyping machines, 3D printers, that allow fast adaptation to all different existing diameters of the screw holes in the market. For the fabrication, dental resins are used, Classified and Certified to stay Permanently in the oral cavity. The printing method is called “Additive Prototyping” as tiny drops of resin are added to a baseplate and then hardened by Laser Light. After a while the design is finished in exactly the shape of the design. This method is fast and very economical in the use of material. There is almost zero material loss. The Plugs provide a Standard Closure Procedure. One Step Protocol for All Dentists. It is a Simplification of the closing procedures. Perfect fitting creates Friction and Vacuum, without the use of other aids. It is faster, cleaner and neater. The Handling Pin offers easy transport and positioning and removing, when needed is made simple by the Sink Hole, that is always in the center of the plug and thus provides the practitioner the exact screw hole pathway. The invention leads to cancellation of the use of previously used inferior materials, like cotton and teflon. One simple action, that saves time. An Efficient New Way, valuable and worthy to the high standards of dental implantology.

Important Remark about the Diameters of all Cylindrical, Conical and Double Cylindrical Plugs:

The diameter seizes in this context as well as in the presented designs of all implant Plugs, Cylindrical, Conical and Double Cylindrical are based on most common diameter seizes of the nowadays existing implant Abutment holes, Conical holes in Crowns and Bridges and screw hole Sleeves. The implant Plugs will be manufactured in the diameters of all existing Abutments and Sleeve Screw Holes. The top and bottom diameters of the Conical Plugs will also differ conform the needs.
Design 1: Cylindrical Plug (1), with Straight leveled Top Head (2). In the center of the cylinder Top Head is a shallow “sinkhole” (8) and directly next to it, at a distance of 0.25 mm a Handling pin (6) with a narrow neck (7) at his base. The handling pin is always perpendicular positioned on the top surface.
   For Diameters see remark above.
Design 2: Cylindrical Plug (1), with 30° degrees angled Top Head (3) for 30° angled sleeves. In the center of the cylinder Top Head a shallow“sinkhole” (8) and directly next to it, at a distance of 0.25 mm and perpendicular at the highest point of the top surface a handling pin (6) with a narrow neck (7)
   For Diameters see remark above.
Design 3: Cylindrical Plug (1) with 45° degrees angled Top Head (4) for 45° angled sleeves. In the center of the cylinder Top Head a shallow“sinkhole” (8) and directly next to it, at a distance of 0.25 mm and perpendicular at the highest point of the top surface, a handling pin (6) with a narrow neck (7) For Diameters see remark above.
Design 4: Cylindrical Plug (1) with 60° degrees angled Top Head (5) for 60° angled sleeves. In the center of the cylinder Top Head a shallow“sinkhole” (8) and directly next to it, at a distance of 0.25 mm and perpendicular at the highest point of the top surface, a handling pin (6) with a narrow neck (7)
   For Diameters see remark above.
Design 5: Conical Plug (9), with Straight Leveled Top Head (2) for open conical holes in Cad/Cam fabricated Screw retained Crowns and Bridges. In the center of the cylinder Top Head a shallow“sinkhole” (8) and directly next to it, at a distance of 0.25 mm and perpendicular on top surface, a handling pin (6) with a narrow neck (7)
   For Diameters see remark above.
Design 6: Double cylindrical Plug (10), with Straight Leveled Top Head (2) for straight ending screw Sleeves in “all on4”, “all on 6” cases and other full arch bridges. This plug consist of a variable in diameter base cylinder (1) and a wider extra cylinder (11) on top with a standard diameter of 3.0 mm and a standard thickness of 1.5 mm. In the center of the cylinder Top Head a shallow“sinkhole” (8) and directly next to it, at a distance of 0.25 mm and perpendicular on top surface, a handling pin (6) with a narrow neck (7) For diameters see remark above.
Design 7: Double cylinder Plug (10), with 30° degrees Angled Top Head (3) for 30° degrees angled sleeve Heads. This plug consist of a variable in diameter base cylinder (1) and a wider extra cylinder (11) on top with a standard diameter of 3.0 mm and a standard thickness of 1.5 mm. In the center of the cylinder Top Head a shallow“sinkhole” (8) and directly next to it at a distance of 0.25 mm and perpendicular at the highest point of the top surface, a handling pin (6) with a narrow neck (7)
   For Diameters see remark on p4.
Design 8: Double cylinder Plug (10), with 45° degrees Angled Top Head (4) for 45° degrees angled sleeve Heads. This plug consist of a base cylinder (1) and a wider extra cylinder (11) on top, with a standard diameter of 3.0 mm and a standard thickness of 1.5 mm. In the center of the cylinder Top Head a shallow“sinkhole” (8) and directly next to it at a distance of 0.25 mm and perpendicular at the highest point of the top surface, a handling pin (6) with a narrow neck (7)
   For Diameters see remark on p4.
Design 9: Double cylinder Plug (10), with 60° degrees Angled Top Head (5) for 60° degrees angled sleeve Heads. This plug consist of a base cylinder (1) and a wider extra cylinder (11) on top, with a standard diameter of 3.0 mm and a standard thickness of 1.5 mm. In the center of the cylinder Top Head a shallow“sinkhole” (8) and directly next to it, at a distance of 0.25 mm and perpendicular at the highest point of the top surface, a handling pin (6) with a narrow neck (7)
   For Diameters see remark on p4.

The present invention, Dental implant Plug, concerns a prefabricated solid plug, made of dental resins, certified for permanent use in the oral cavity, fabricated by rapid prototyping machines, 3D printers. This 3D printing method is called additive prototyping or manufacturing. Small layers or drops of resin are placed on a base and then hardened each layer by Laser light. Drop after drop is added until the final designed scheme has reach its shape. It is also an economical method as no material is getting waste. The Plugs consists of a one piece part, that includes a Plug, a Handling Pin and a Sinkhole. The Plugs close the holes that exist after screwing Abutments, Crowns, Bridges and all Titanium or Zirconium Screw Sleeves on Implants. All screw retained constructions serve one Goal and that is, that the implants under the prosthetics have to be accessible all the time. When unscrewing is needed, it has to be done easy. On the contrary one cannot leave the holes open not leave the holes open. They all have to be closed easily and be reopened easily. The Closing Procedure is the procedure that can be improved by the Implant Plugs. They provide a One Step Protocol for all dentists. The plugs are easily handled and transported into the Holes by a Handling pin, positioned always perpendicular on the top heads of the Plugs, directly next to the sinkhole. The Pins have a narrow neck at the base of top head of the Plug, that is designed for Easy Chipp Off at that spot exactly, when the plug has reached its final Position. At the moment of placing the Plug in the Holes, due to the precise and tight fitting of the plugs, as they are fabricated in the exact diameters of the internal spaces of the holes, they cause a friction and a vacuum in the holes and create a strong connection without the use of other aids. After chipping off the pin, the Plugs can only be removed by drilling them away. The plugs are also produced in different most common colors to match the environment of the teeth and gingiva. That creates sometimes a problem as the color matching makes them invisible. For that reason the Plugs are provided by a shallow Sinkhole for recognition by the dentists and simultaneously delivering an orientation point of not only where exactly is the Plug, but also where is the exact pathway of the screw hidden beneath the Plug. Therefore is the sinkhole always positioned exactly in the center. It has been mentioned, that the screw heads have to stay protected to always leave the access of the screwdriver into this screw heads open. Until now this protection happens by first placing Cottons or Teflon at the base of the screw head. The tightness of the Implant Plugs causes a Hermetical Closure. Nothing can bother the screw head anymore.

The presented invention makes further use of this inferior materials as cotton and teflon unnecessary.

The Plugs are produced in different forms and shapes:

Cylindrical Plugs with Straight Leveled Top Heads for Abutment screw holes.

Cylindrical Plugs with 30°, 45° and 60° degrees Angled Leveled Top Heads for 30°, 45° and 60° degrees Angled Shaped Screw Sleeves.

Conical Plugs with only Straight Leveled Top Heads for screw retained Crowns.

Double Cylindrical Plugs with straight leveled Top Heads and Double Cylindrical Plugs with 30°, 45° and 60° degrees Angled Leveled Top Heads for 30°, 45° and 60° degrees Angled Shaped Screw Sleeves.

The Double Cylindrical Plugs are specific designed for use in the first place by Dental Technicians. In the startup stage of the manufacturing procedure of “All on 4” and “All on 6” prosthetic constructions, the Titanium Sleeves are placed on the implants in the models and adapted to the occlusion, the inter-occlusal space and articulation.

In most of these constructions the Sleeves leave non aesthetic black holes in the prosthetics, as the Sleeves of Titanium are black colored and even when filled up in the ways it happens now, these black sleeve hole endings keep showing up and definitely don't disappear satisfactory. This is a general complain from most patients, but also the dentists themselves don't like that. There is no alternative or better solution offered so far. That's why it is silently accepted. Now with a few special, simple extra instructions, handed to the technicians, a new technique will be applied to make these ugly black hole endings optically disappear and create a better aesthetic satisfaction for both patients and dentists.

In the stage, that the dental technician places the Titanium Screw Sleeves on the implants in the models and adapts them to the inter-occlusal spaces, he will now shorten the sleeves by an extra 1.5 mm, what is exactly the standard thickness of the extra top Cylinder of the Double Cylindrical Plugs. The inclination of the top surface of the Sleeve will also be estimated by the technician in this stage.
Then he can place the Double Cylindrical Plug in the titanium Sleeves and proceed with the Wax build-up of the “all on 4” and “all on 6” Constructions. When the constructions are finished, the Double Cylindrical Plugs will perfectly fit in the existing Straight levels or Angled levels of the Sleeves in the prosthetics.

This is a System Improvement, that will provide extra satisfaction to the dentists, but definitely also to the patients, as the black visible holes will be disappeared. Far over Hundreds of Thousands of these Constructions are placed in the same amount of mouths worldwide. Every few years many of these constructions have to be unscrewed for check-ups and maintenance and tartar removing reasons. In all that old situations the Cylindrical Plugs can be used and will offer a more correct closure of the holes and time saving for the dentists. The Double Cylindrical Plugs will add Value to the New to be fabricated “all on 4” and “all on 6” constructions and deliver System Improvement.

The above mentioned characteristics as well as other characteristics as Diameters and Distances and Widths in mm of the presented invention, will be explained and presented clearly and analytically in the following detailed description of the 9 different shape editions of the invention in combination with the 9 designs for realization of the invention and manifesting the implementation of the invention.

Design 1:

Cylindrical Plug (1),

with Straight leveled Top head (2) for straight screw holes of Abutments and all other straight leveled open screw holes of screw Sleeves. The height of the plug is 5 mm. The Diameter of the Cylinder Plugs in all designs is 2.0 mm and is an example. All diameters will vary conform existing screw holes. Any specific straight abutment has its own internal screw hole space. When the internal diameter of the hole is known, the plug can be made. The cylindrical plug of dental resin is manufactured by 3d printer conform the design: A cylinder with the diameter conform the internal diameter of the Abutment or Sleeve, per example 2.0 mm and a standard height of 5 mm. On top of the cylinder, in the center of the top head is a shallow Sinkhole (8) of 0.5 mm diameter and 0.5 mm deep. Directly next to the sinkhole (8) and at a distance of 0.25 mm is a thin Handling Pin (6) perpendicular positioned on the top surface. The handling Pin (6) has a height of 2.0 mm and a thickness of 1.0 mm. The pin (6) is in contact with the base cylinder with a narrow Neck (7) of 0.5 mm diameter. The Handling Pin (6) changes its diameter gradually from 1.0 mm to 0.5 mm at a height of 1.0 mm from the base of the cylinder. This Neck (7) serves the easy Chip off of the pin at the right spot. When the Abutment or Sleeve is screwed on the implant, then the tight fitting ready fabricated plug placed into the hole creates a friction and a vacuum. The plug is pushed in place and the handling pin (6) is chipped off at the narrow neck (7). The length (height) of the plug can be shortened at the bottom, if needed.

NOTE for all Angled Sleeves and Angled Plug Designs:
There are no prefabricated Angled Sleeves.
Only Straight Sleeves are used in all cases.
The Angles of the Sleeve Top Heads are created and modified by the technicians and will Now be adapted to the Standard Angles of 30°, 45° and 60° degrees top head Plugs.

All Plugs will be delivered to the dentist ready to use.

Design 2:

Cylindrical Plug (1),

with 30° degrees Angled Top Head (3) for 30° degrees Angled Sleeves. Any specific 30° degrees top leveled screw sleeve has its own internal screw space and are slightly different in diameters. When the internal diameter of the sleeve is known, the plug can be made. The cylindrical plug of dental resin is manufactured by 3d printer machines, conform the design:
A cylinder of the exact diameter of the specific internal diameter of the sleeve, per example 2.0 mm and a height of 5.0 mm on the high side of the cylinder. From the high side starts the 30° inclination angle (3). Thus on the low side, the height of the cylinder is 3.8 mm.

On top of the cylinder, in the center of the top head is a shallow Sinkhole (8) of 0.5 mm diameter and 0.5 mm deep. Directly next to the sinkhole (8), at a distance of 0.25 mm, is a thin Handling Pin (6) perpendicular positioned on the highest point of the top surface. The handling Pin (6) has a height of 2.0 mm and a thickness of 1.0 mm. The pin (6) is in contact with the base cylinder with a narrow Neck (7) of 0.5 mm diameter. The Handling Pin (6) changes its diameter gradually from 1.0 mm to 0.5 mm at a height of 1.0 mm from the base of the cylinder. This Neck (7) serves the easy chip-off of the pin at the right spot. When the Abutment or Sleeve is screwed on the implant, then the tight fitting ready fabricated plug placed into the hole creates a friction and a vacuum. The plug is pushed in place and the handling pin (6) is chipped off at the narrow neck (7). The length (height) of the plug can be shortened at the bottom, if needed.

Design 3:

Cylindrical Plug (1),

with 45° degrees angled Top Head (4) for 45° angled sleeves. Any specific 45° angled abutment has its own internal screw space as the standard straight sleeve. When the internal diameter is known, the plug can be made. The cylindrical plug of dental resin is manufactured by 3d printer machines, conform the design:
A cylinder of the exact diameter of the specific internal diameter of the sleeve, per example 2.0 mm and a height of 6.0 mm on the high side. From the high side starts the 45° inclination angle (4). Thus on the low side, the height of the cylinder is 3.8 mm.

On top of the cylinder, in the center of the top head is a shallow Sinkhole (8) of 0.5 mm diameter and 0.5 mm deep. Directly next to the sinkhole (8), at a distance of 0.25 mm, is a thin Handling Pin (6) perpendicular positioned on the highest point of the top surface. The handling Pin (6) has a height of 2.0 mm and a thickness of 1.0 mm. The pin (6) is in contact with the base cylinder with a narrow Neck (7) of 0.5 mm diameter. The Handling Pin (6) changes its diameter gradually from 1.0 mm to 0.5 mm at a height of 1.0 mm from the base of the cylinder. This Neck (7) serves the easy chip-off of the pin at the right spot. When the Abutment or Sleeve is screwed on the implant, then the tight fitting ready fabricated plug placed into the hole creates a friction and a vacuum. The plug is pushed in place and the handling pin (6) is chipped off at the narrow neck (7). The length (height) of the plug can be shortened at the bottom, if needed.

Design 4:

Cylindrical Plug (1),

with 60° degrees angled Top Head (5) for 60° angled sleeves. Any specific 60° angled abutment has its own internal screw space as the standard straight sleeve. When the internal diameter is known, the plug can be made. The cylindrical plug of dental resin is manufactured by 3d printer machines, conform the design:
A cylinder of the exact diameter of the specific internal diameter of the sleeve, per example 2.0 mm and a height of 6.5 mm on the high side. From the high side starts the 60° inclination angle (5). Thus on the low side, the height of the cylinder is 3.1 mm. On top of the cylinder, in the center of the top head is a shallow Sinkhole (8) of 0.5 mm diameter and 0.5 mm deep.

Directly next to the sinkhole (8), at a distance of 0.25 mm, is a thin Handling Pin (6) perpendicular positioned on the highest point of the top surface. The handling Pin (6) has a height of 2.0 mm and a thickness of 1.0 mm. The pin (6) is in contact with the base cylinder with a narrow Neck (7) of 0.5 mm diameter. The Handling Pin (6) changes its diameter gradually from 1.0 mm to 0.5 mm at a height of 1.0 mm from the base of the cylinder. This Neck (7) serves the easy chip-off of the pin at the right spot. When the Abutment or Sleeve is screwed on the implant, then the tight fitting ready fabricated plug placed into the hole creates a friction and a vacuum. The plug is pushed in place and the handling pin (6) is chipped off at the narrow neck (7). The length (height) of the plug can be shortened at the bottom.

Important Remark about Conical Plugs Below.

What concerns the Conical Plugs. The Conical Plugs will be handled and chosen by the technician. The screw retained Crown has to be fabricated first. Screw retained crowns are created with Cad/Cam procedures, i.e. first designed by computer software and then milled in a milling machine from ready porcelain blocks where the screw hole is already for seen and calculated.

The prefabricated hole diameters in these specific blocks in the implant market are known. The upper and lower diameters of the conical holes in the final crowns differ steadily depending of the thickness of the crown.
Technically it is not possible to find the right conical plug for all conical holes immediately. Conical Plugs have to be matched to the crown holes because of the following reason:

The Cone shape of the Plugs have to be adapted to the Cone shapes of the Crowns. There are bigger and smaller Crowns plus every Cone shape may differ in diameter at the top and at the base. Small (S) or Large (L) editions will be provided, but possible even more. So all cones have to be chosen after the crown is ready.
The technician decides which Plug suits best.
The top of the Plugs will most often exceed the occlusal surface of the crown. The conical plug has a length of 6.0 mm, that can be shortened at the base but that does not mean, that the top head with the handling pin and the sinkhole will be always exactly at the right occlusal level. Sometimes the top head has to be corrected and in that case the sinkhole disappears.

The Friction and Vacuum Effect has to be Guaranteed.
So the adaptation of the conical plug to the crown will be necessary by the dentist in most cases. The technician will help to deliver the most suitable plug to the dentist. The dentist will receive the right plug with the handling pin and sinkhole on top for easy Placement.

The dentist will experience the friction and the vacuum effect and will than chipp off the handling pin. The exceeding part of the plug to the exact occlusion can be corrected in a few seconds.

Design 5:

Conical Plug (9),

with Straight Leveled Top Head (2) for open Conical Holes in Cad/Cam fabricated Screw retained Crowns. In these conical screw holes, the diameters vary, not only on the top and bottom of the cones, but also the range in between and further are these diameters depending on the final heights of the crowns. As indications of existing conical screw holes, the following 2 ranges are mentioned in Design 5: an S edition (diameter range of 2.0-2.4 mm) and a L edition (diameter range of 2.0-2.8 mm). If more Conical Diameter Ranges are demanded, they will be provided.
The technician has his crown ready. So the top diameter as well as the bottom diameter is known. The plug can be chosen. The conical plug (9) is manufactured by 3d printer and made of dental resin. Per example, the height of the crown is 6 mm till the screw head. The bottom diameter is 2.0 mm and the top diameter is 2,4.

On top of the cylinder, in the center of the top head is a shallow Sinkhole (8) of 0.5 mm diameter and 0.5 mm deep. Directly next to the sinkhole (8), at a distance of 0.25 mm, is a thin Handling Pin (6) perpendicular positioned on the top surface. The handling Pin (6) has a height of 2.0 mm and a thickness of 1.0 mm. The pin (6) is in contact with the base cylinder with a narrow Neck (7) of 0.5 mm diameter. The Handling Pin (6) changes its diameter gradually from 1.0 mm to 0.5 mm at a height of 0.5 mm from the base of the cylinder. This Neck (7) serves the easy chip-off of the pin at the right spot. When the Crown is screwed on the implant, then the tight fitting ready fabricated plug, placed into the hole, creates a friction and a vacuum. The plug is pushed in place and the handling pin (6) is chipped off at the narrow neck (7). The dentist will correct the height conform occlusion.

Important remark about Double Cylindrical Plugs:

The Double Cylindrical Plug will be specifically handled by the dental technicians in the first place as these plugs will be implemented by them in the fabrication process of the prosthetic construction. A special instruction will be given to the technician how to use the Plug during the fabrication process. The Titanium Sleeves, after being placed on the model and corrected conform inter-occlusal space and articulation, will have to be shortened an extra 1.5 mm. The technician will now choose one of the 4 available double cylindrical plugs, the straight leveled, the 30° leveled, the 45° leveled or the 60° leveled one. Then the Double Cylindrical Plugs will be situated on the sleeves and the waxing process can proceed. The characteristic top cylinder diameter is standard 3 mm and has a thickness of 1.5 mm. The base cylinder has a variable diameter and that is an advantage here as the dental technician needs to choose a Diameter, that has a 5-10% smaller diameter than the Plugs that will come with the prosthetics delivered finally to the dentist.
Why?

The essential characteristic of the plugs is their tight fit, since they have the exact diameters conform the internal cylindrical space of the Sleeves and create therefore the friction and vacuum during placement. That would not be realistic though in the production stage. So the special instruction to use a 5-10% less diameter, i.e. instead of a 2.0 mm diameter of the base Cylinder of the Double Cylindrical Plugs, the technician will use a 1.9 or 1.8 mm diameter Plug in the production stage, that is still very stable, but will be more practical and will not have a friction, what would bother the handling in this phase, what means placing and removing in the sleeves during construction is easy. Only the 2.0 mm diameter Plugs will provide the friction and vacuum. That plug will be finally delivered to the dentist together with the finished prosthetics.

All different diameters for cylindrical, conical and double cylindrical Plugs will be provided to be adapted and implemented in all cases.

Design 6:

Double Cylindrical Plug (10), straight leveled top head (2) for straight screw sleeves, generally used in “all on 4”, “all on 6” constructions and exclusively for use by dental technicians. Any specific titanium screw sleeve has its own internal diameter. When the sleeve diameter is known, the plug can be made. The plug has a height of the base cylinder (10) of 5.0 mm and the diameter is conform the internal sleeve diameter. The Standard Height of the top cylinder (11) is 1.5 mm and the Standard diameter is 3.0 mm. The dental technician shortens the titanium sleeves 1.5 mm shorter than normal. He than places the double cylinder plug on the sleeve and starts his “all on 4” or “all on 6” supra-construction fabrication. The double cylinder plug (10) participates in the wax build up and at the finishing stage the plug will adapt precisely in the “mall”, that has been created. On top of the cylinder, in the center of the top head is a shallow Sinkhole (8) of 0.5 mm diameter and 0.5 mm deep. Directly next to the sinkhole (8), at a distance of 0.25 mm, is a thin Handling Pin (6) perpendicular positioned on the top surface. The handling Pin (6) has a height of 2.0 mm and a thickness of 1.0 mm. The pin (6) is in contact with the base cylinder with a narrow Neck (7) of 0.5 mm diameter. The Handling Pin (6) changes its diameter gradually from 1.0 mm to 0.5 mm at a height of 1.0 mm from the base of the cylinder. This Neck (7) serves the easy chip-off of the pin at the right spot. When the Abutment or Sleeve is screwed on the implant, then the tight fitting ready fabricated plug placed into the hole creates a friction and a vacuum. The plug is pushed in place and the handling pin (6) is chipped off at the narrow neck (7). The length (height) of the plug can be shortened at the bottom.

Design 7:

Double Cylindrical Plug (9), 30° degrees Angled Top Level (3) for 30° degrees angled sleeve heads, generally used in “all on 4”, all on 6″ constructions and exclusively for use by dental technicians. What technicians have to do with the double cylinder plug is to implement it in the “all on 4” production, by first shorten the sleeves 1.5 mm extra and create 30° angle at the top of the sleeve. (or 45° or 60° degrees, whatever angle comes closer to the anatomy in the prosthetic construction) and then place the plug on the sleeves. The double cylinder plug with top head level of 30° degrees (3) participates in the wax build up and at the finishing stage the plug will adapt precisely in the “mall” (the prosthetic hybrid bridge), that has been created. Any specific titanium screw sleeve has its own internal diameter. When the internal sleeve diameter is known, the plug can be made. Height of the base cylinder (1) 5.0 m on the high side. From the high side starts the 30° inclination angle (3). Thus on the low side, the height of the cylinder is 3.8 mm. The Height of the top cylinder (11) 1.5 mm. Diameter is 3.0 mm. On top of the cylinder, in the center of the top head is a shallow Sinkhole (8) of 0.5 mm diameter and 0.5 mm deep. Directly next to the sinkhole (8), at a distance of 0.25 mm, is a thin Handling Pin (6) perpendicular positioned on the highest point of the top surface. The handling Pin (6) has a height of 2.0 mm and a thickness of 1.0 mm. The pin (6) is in contact with the base cylinder with a narrow Neck (7) of 0.5 mm diameter. The Handling Pin (6) changes its diameter gradually from 1.0 mm to 0.5 mm at a height of 1.0 mm from the base of the cylinder. This Neck (7) serves the easy chip-off of the pin at the right spot. When the Abutment or Sleeve is screwed on the implant, then the tight fitting ready fabricated plug placed into the hole creates a friction and a vacuum. The plug is pushed in place and the handling pin (6) is chipped off at the narrow neck (7). The length (height) of the plug can be shortened at the bottom.

Design 8:

Double Cylindrical Plug (10), 45° degrees Angled Top Level (4) for 45° degrees angled sleeve heads, generally used in “all on 4”, “all on 6” constructions and exclusively for use by dental technicians. What technicians have to do with the double cylinder plug is to implement it in the “all on 4” production, by first shorten the sleeves 1.5 mm extra and create 45° angle at the top of the sleeve. (or 30° or 60° degrees, whatever angle comes closer to the anatomy in the prosthetic construction) and then place the plug on the sleeves. The double cylinder plug with top head level of 45° degrees (4) participates in the wax build up and at the finishing stage the plug will adapt precisely in the “mall” (the prosthetic hybrid bridge), that has been created. Any specific titanium screw sleeve has its own internal diameter. When the internal sleeve diameter is known, the plug can be made. Height of the base cylinder (1) 6.0 mm on the high side. From the high side starts the 45° inclination angle (4). Thus on the low side, the height of the cylinder is 3.8 mm. The Height of the top cylinder (11) is 1.5 mm On top of the cylinder, in the center of the top head is a shallow Sinkhole (8) of 0.5 mm diameter and 0.5 mm deep. Directly next to the sinkhole (8), at a distance of 0.25 mm, is a thin Handling Pin (6) perpendicular positioned on the highest point of the top surface. The handling Pin (6) has a height of 2.0 mm and a thickness of 1.0 mm. The pin (6) is in contact with the base cylinder with a narrow Neck (7) of 0.5 mm diameter. The Handling Pin (6) changes its diameter gradually from 1.0 mm to 0.5 mm at a height of 1.0 mm from the base of the cylinder. This Neck (7) serves the easy chip-off of the pin at the right spot. When the Abutment or Sleeve is screwed on the implant, then the tight fitting ready fabricated plug placed into the hole creates a friction and a vacuum. The plug is pushed in place and the handling pin (6) is chipped off at the narrow neck (7). The length (height) of the plug can be shortened at the bottom.

Design 9:

Double Cylindrical Plug (9), 60° degrees Angled Top Level (5) for 60° degrees angled sleeve heads, generally used in “all on 4”, “all on 6” constructions and exclusively for use by dental technicians. What technicians have to do with the double cylinder plug is to implement it in the “all on 4” production, by first shorten the sleeves 1.5 mm extra and create 60° angle at the top of the sleeve. (or 30° or 45° degrees, whatever angle comes closer to the anatomy in the prosthetic construction) and then place the plug on the sleeves. The double cylinder plug with top head level of 60° degrees (5) participates in the wax build up and at the finishing stage the plug will adapt precisely in the “mall” (the prosthetic hybrid bridge), that has been created. Any specific titanium screw sleeve has its own internal diameter. When the internal sleeve diameter is known, the plug can be made. Height of the base cylinder (1) 6.5 mm. From the high side starts the 60° inclination angle (5). Thus on the low side, the height of the cylinder is 3.1 mm. On top of the cylinder, in the center of the top head is a shallow Sinkhole (8) of 0.5 mm diameter and 0.5 mm deep. Directly next to the sinkhole (8), at a distance of 0.25 mm, is a thin Handling Pin (6) perpendicular positioned on the highest point of the top surface. The handling Pin (6) has a height of 2.0 mm and a thickness of 1.0 mm. The pin (6) is in contact with the base cylinder with a narrow Neck (7) of 0.5 mm diameter. The Handling Pin (6) changes its diameter gradually from 1.0 mm to 0.5 mm at a height of 1.0 mm from the base of the cylinder. This Neck (7) serves the easy chip-off of the pin at the right spot. When the Abutment or Sleeve is screwed on the implant, then the tight fitting ready fabricated plug placed into the hole creates a friction and a vacuum. The plug is pushed in place and the handling pin (6) is chipped off at the narrow neck (7). The length (height) of the plug can be shortened at the bottom.

1. Dental Implant Plug (1,9,10) consists of a Plug (1,9,10), a Handling Pin (6,7) and a Sinkhole (8), that form a single compact body.
The plug is used by dentists to close the holes, that exists after screwing abutments on dental implants, after screwing screw-retained crowns on implants, after screwing full arch bridges on multiple implants as well as after screwing hybrid bridges as a fixed unit on 4 or 6 implants (“all on 4”, “all on 6”), where screws pass through special Sleeves, that form the passways for the screws to connect the construction on the implants and are incorporated in the constructions by the dental technicians.
Plugs (1,9,10) characterised by 3 different Shapes:
Cylindrical Plugs (1), Conical Plugs (9) and Double Cylindrical Plugs (10) and by 4 different inclinations:
Straight Leveled Top Heads (2) and 30° leveled (3), 45° leveled (4) and 60° leveled (5) top heads.
Cylindrical Plugs (1) and Double Cylindrical Plugs (10) characterised by:
Straight leveled Top Heads (2) and Angled Leveled Top Heads (3,4,5).
Conical Plugs (9) characterised by only Straight Leveled Top Heads (2) Double Cylindrical Plugs (10) characterised by an extra cylinder (11) on Top of the Base Cylinder (1). This extra cylinder has a Standard Diameter of 3.0 mm and a Standard Thickness of 1.5 mm.
All plugs (1,9,10) characterised by a Sinkhole (8) in the center of the top surface, 0.5 mm in diameter and 0.5 mm in depth and directly next to it, at a distance of 0.25 mm a Handling Pin (6), always perpendicular positioned on the top surface and in case of inclinations always positioned at the highest point of the top surface. The Handling pin has a diameter of 1.0 mm and a length of 2.0 mm and characterised by a Narrow Neck (7). The diameter of the Handling pin (6) changes gradually from 1.0 mm to 0.5 mm at a height of 0.5 mm from the base of the cylinder and where it reaches the top head surface, the diameter is 0.5 mm. This Narrow Neck (7) serves the easy chipp-off and breaking point of the handling pin at the right spot after the plug is definitely placed in the hole.

2. Plugs (1,9.10) conform claim 1.
characterised by the Conical Plug (9) that has only straight leveled top heads (2) and a length of 6.0 mm and by the Cylindrical plug (1) and the Double Cylindrical plug (10) that have a basic cylinder (1) length of 5.0 mm

3. Plugs (1,9,10) conform claim 1.
characterised by the Cylindrical Plug and the Double Cylindrical plugs with inclined top leveled surfaces, that have, due to that inclinations a different length of the basic cylinders (1) at the high end and at the low end. The plugs with 30° inclined top levels have basic cylinders (1) with 5.0 mm length at the high end and 3.8 mm at the low end. The plugs with 45° inclined top levels have basic cylinders with 6.0 mm length at the high end and 3.8 mm at the low end. The plugs with 60° inclined top levels have basic cylinders (1) with 6.5 mm length at the high end and 3.1 mm at the low end.

4. Plugs (1,9,10) conform claim 1
characterised by the Double Cylindrical Plug with the 4 different top levels (2,3,4,5), that all have an extra cylinder (11) on top of their basic Cylinder (1) with a standard diameter of 3.0 mm and a standard height of 1.5 mm.

5. Plugs (1,9,10) conform claim 1
characterised by the Double Cylindrical Plug (10) that has 2 goals simultaneously, firstly the basic cylinder (1) is used to close the screw hole that is left open, secondly the extra cylinder (11) on top of the basic cylinder (1) serves the goal to make the black titanium sleeve endings invisible in most “all on4”, “all on6” constructions. This is a system improvement that leads to better patient as well as dentists satisfaction. Initially The Double Cylinder plugs are intended exclusively for the dental technicians to adapt the sleeves in the “all on4”, “all on6” constructions to the plugs in such a way that finally the black titanium sleeve endings remain invisible. All technicians will receive special, but simple instruction information and subsequently the plugs will be delivered from the dental technicians together with the final prosthetic work to the dentists for final placement.

6. Plugs (1,9,10) conform
characterised by different diameters. All plugs are manufactured with the diameters precisely conform the diameters of all, now and in the future, in the dental market present internal open holes, that exist after screwing abutments on implants, after screwing screw retained crowns and bridges on implants, after screwing Sleeves that are incorporated in full arch bridges or in the “all on 4”, “all on 6” constructions on implants, creating, due to precise fit a friction and a vacuum, resulting in permanent tight fitting without the need of other aids.

7. Plugs (1,9,10) conform claim 1
characterised by the narrow Sinkhole (8), that, always situated in the center of the top head surface of the plug, provides a recognition point for the dentist and a orientation guide to find the right pathway of the screw in case the supraconstruction has to be unscrewed.
Also characterised by the Handling pin (6) that provides easy handling and transport of the plug into the screw hole. The handling pin (6) has a characteristic narrow Neck (7) that serves the easy chipp-off the pin from the plug when the placement has finished.

8. Plugs (1,9,10) conform claim 1
characterised by the fabrication of dental resin, classified and certified for the oral cavity, by means of Rapid Prototyping 3D Printers with the method “additive prototyping”. The different designs are added to special designer software and initiate the 3D printer to produce microns, tiny drops of resin step by step in a fluid situation on a special base platform. These drops are hardened simultaneously until the Plug exist as a homogeneous solid product. Multiple Plugs of different shapes and in different colors of white to the color of gingiva, will be produced.
